(19) United States
(12) Patent Application Publication
(10) Pub. No.: US 2024/0057729 A1
(43) Pub. Date: Feb. 22, 2024

(54) Interlocking Metasurfaces

(71) Applicant: National Technology & Engineering Solutions of Sandia, LLC, Albuquerque, NM (US)

(72) Inventors: Brad Boyce, Albuquerque, NM (US); Philip Noell, Albuquerque, NM (US); Nicholas Leathe, Albuquerque, NM (US); Ophelia Bolmin, Albuquerque, NM (US); Benjamin Young, Albuquerque, NM (US)

(21) Appl. No.: 17/888,846

(22) Filed: Aug. 16, 2022

(51) Int. Cl. A44B 18/00; B33Y 80/00

(52) U.S. Cl. CPC A44B 18/0053; B33Y 80/00

(57) ABSTRACT

Additive manufacturing (AM) can be used to fabricate a wide palette of interlocking metasurfaces (ILMs). ILMs can be architecturally tailored to achieve intentional engagement and disengagement forces, and are amenable to topological optimization. ILMs can be fabricated using nearly any AM process at different length scales according to the capabilities of the process. As a result, ILMs represent a new class of joining technology enabled by additive manufacturing that is complementary to traditional joining processes including fasteners, welds, adhesives, etc.

### STATEMENT OF GOVERNMENT INTEREST

This invention was made with Government support under Contract No. DE-NA0003525 awarded by the United States Department of Energy/National Nuclear Security Administration. The Government has certain rights in the invention.

### FIELD OF THE INVENTION

The present invention relates to metasurfaces and, in particular, to interlocking metasurfaces enabled by additive manufacturing.

### BACKGROUND OF THE INVENTION

Metasurfaces are topologically architected arrays of surface features that can imbue unique and unusual properties. There has been a particular interest of late in the potential for metasurfaces to control wave dynamics, leading to applications in acoustics, optics, electromagnetism, and elastodynamics. See G. Ma et al., Nat. Mater. 13, 873 (2014); Y. Chong et al., Phys. Rev. Lett. 105, 053901 (2010); D. R. Smith et al. Science 305, 788 (2004); A. Arbabi et al., Nat. Photonics 11, 415 (2017); S. Sun et al., Adv. Opt. Photonics 11, 380 (2019); and C. Boutin et al., J. Appl. Phys. 117, 064902 (2015).

Interlocking metasurfaces (ILMs), are a type of metasurface wherein arrayed features enable the attachment of mating metasurfaces. ILMs first emerged through the use of microfabrication in the 1990's. Microfabrication enabled the manufacture of complex feature arrays, and ILMs offered a potential solution to challenges with microassembly. Examples of ILMs include “m icro-velcro”, silicon snap fasteners, micro-molded connectors, and thin interlocking cantilevers. See M. L. Reed et al., Adv. Mater. 4, 48 (1992); R. Prasad et al., “Design, fabrication, and characterization of single crystal silicon latching snap fasteners for micro assembly,” Proc. ASME Int. Mech. Eng. Congress and Exposition (IMECE′95), San Francisco, CA, Nov. 1995; A. G. Gillies and R. Fearing, J. Micromech. Microeng. 20, 105011 (2010); and G. A. Garcia et al., J. Electron. Packag. 144, 041004 (2021). However, the microfabrication techniques employed have limitations with regard to the topologies achievable and the constituent materials. See M. L. Reed et al., Adv. Mater. 4, 48 (1992); R. Prasad et al., “Design, fabrication, and characterization of single crystal silicon latching snap fasteners for micro assembly,” Proc. ASME Int. Mech. Eng. Congress and Exposition (IMECE′95), San Francisco, CA, November 1995; A. G. Gillies and R. Fearing, J. Micromech. Microeng. 20, 105011 (2010); H. Ko et al., Nano Lett. 9, 2054 (2009); and J. J. Brown and V. M. Bright, J. Microelectromech. Syst. 25, 356 (2016). Specifically, ILMs typically consist of a stack of a few patterned planar films with extruded 2D shapes. The constituent materials have been limited to materials, such as silicon, that are amenable to the microfabrication process but not necessarily ideal for structural latching applications. Moreover, in the existing examples of ILMs, most have relied on the development of a custom manufacturing process tailored for the explicit patterning of the ILM. For these reasons, there have been only a handful of studies reporting on the development of ILMs to date, and none have gained commercial traction.

### SUMMARY OF THE INVENTION

Interlocking metasurfaces (ILMs) enable the joining of metasurfaces through mechanical interlocking of architected array of features. While the concept of ILMs has its roots in microfabrication, the recent proliferation of additive manufacturing offers the opportunity to dramatically broaden the range of solutions. Several additive manufacturing technologies are described herein to explore the ILM design space. Using these technologies, ILMs can be manufactured in a variety of materials ranging from microscale polymers to metals. Selected designs are experimentally characterized to estimate the insertion and disengagement forces, and the tensile strength. Finite element simulations are developed to illustrate ways ILMs can be architecturally tailored to fine-tune performance. As a result, ILMs comprise a new joining technology that complements traditional joining techniques such as bolts, welds, adhesives, etc. Their potential applications are vast, ranging from vessels to lattices.

### BRIEF DESCRIPTION OF THE DRAWINGS

The detailed description will refer to the following drawings, wherein like elements are referred to by like numbers.

FIGS. 1A and 1B are comparison maps between ILMs and traditional joining technologies. FIG. 1A shows that ILMs are complementary to traditional joining technologies and can be used as a line or surface joint. FIG. 1B shows that ILMs can form non-permanent joints that are easy to assemble.

FIGS. 2A and 2B are examples of applications where ILMs can be used to join polymer and metal 3D printed parts. FIG. 2A shows an ILM design used to join a vessel. FIG. 2B shows an ILM design used to join two dual rhombic dodecahedron lattices.

FIGS. 3A-C show prints of a subset of exemplary ILM designs at the meso and micro scales fabricated using three different AM processes. FIG. 3A shows a split arrowhead ILM printed using the polyjet process. FIG. 3B shows a full arrowhead side of the locked split arrowhead ILM using the nanoscribe process. FIG. 3C shows a sliding T-slot ILM printed using the LBPF process.

FIGS. 4A-D show exemplary ILM designs and their corresponding measured engagement and disengagement forces. For all designs, the engagement direction is shown in a solid arrow and the possible intentional disengagement directions in a dashed arrow. FIG. 4A shows a sliding T-slot ILM. FIG. 4B shows a snapping T-slot ILM. FIG. 4C is a graph of forces measured for the sliding T-slot ILM. FIG. 4D is a graph of forces measured for the snapping T-slot ILM. All forces are normalized by number of features for each test sample.

FIGS. 5A-D shows other exemplary ILM designs and their corresponding measured engagement and disengagement forces. For all designs, the engagement direction is shown in a solid arrow and the possible intentional disengagement directions in a dashed arrow. FIG. 5A shows a split arrowhead ILM. FIG. 5B shows a locked split arrowhead ILM. FIG. 5C is a graph of forces measured for the split arrowhead ILM. FIG. 5D is a graph of forces measured for the locked split arrowhead ILM. All forces are normalized by number of features for each test sample.

FIGS. 6A-D show the tensile response of the exemplary ILM designs. FIG. 6A is a graph of tensile response for a sliding T-slot ILM. FIG. 6B is a graph of tensile response for a snapping T-slot ILM. FIG. 6C is graph of tensile response for a split arrowhead ILM. FIG. 6D is graph of tensile response for a locked split arrowhead ILM.

FIG. 7A shows split arrowhead ILM parameters considered for the FEA analysis. FIG. 7B is a graph of normalized insertion and disengagement forces per unit cell estimated using FEA for various lengths (L) and overlap (a). FIG. 7C shows a printed split arrowhead feature with the original CAD geometry superimposed. The scale bar represents 0.5 mm. FIG. 7D is a graph of insertion and disengagement forces per unit cell from FEA simulations considering the original CAD geometry, a modified CAD geometry to reflect the true printed dimensions, and experimental results for the split arrowhead ILM insertion force (5 by 5 array).

FIG. 8A is a schematic illustration of T-slot features arranged on a circular metasurface to accommodate for axial engagement. FIG. 8B is a schematic illustration of T-slot features arranged on an undulating circular metasurface to accommodate a specific axial engagement. FIG. 8C is a photograph of a hybrid metasurface comprised of T-slots and arrowheads. FIG. 8D shows side view and top view photographs of metasurfaces comprised of finger-like locking features that a snap-fit with mating toadstool-like features. FIG. 8E is a schematic illustration of a metasurface comprising circular split arrowhead features arrayed in a hexagonal pattern. FIG. 8F is a schematic illustration of a metasurface comprising U-shaped surface features arrayed in a square grid pattern. FIG. 8G is a schematic illustration of a metasurfaces that engage using slots that have a curved or arched path. FIG. 8H is a schematic illustration of a circular metasurface that uses a pin to engage a zigzag slot in the mating metasurface. FIG. 8I is a schematic illustration of a first metasurface comprising an array of T-shaped surface features that slide into and then lock into hollow T-shaped features on the mating metasurface. FIG. 8J is a schematic illustration of modified snapping T-slot comprising a half-dome at the top of each T feature that provides a type of mechanical diode. FIG. 8K is a schematic illustration of a sliding T-slot ILM printed with a gradient of materials to localize mechanical properties across the metasurface.

### DETAILED DESCRIPTION OF THE INVENTION

The present invention is directed to ILMs that can be fabricated through additive manufacturing (AM) processes. Over the past decade, AM has gained tremendous popularity as a manufacturing and prototyping technique. Various AM processes have been developed, enabling the fabrication of parts in a variety of materials including polymers, ceramics, and metals at size scales ranging from micrometers to meters. See L. J. Tan et al., Adv. Funct. Mater. 30, 2003062 (2020); Y. Lakhdar et al., Prog. Mater. Sci. 116, 100736 (2021); J. J. Lewandowski and M. Seifi, Annu. Rev. Mater. Res. 46, 151 (2016); G. D. Goh et al., Adv. Mater. Technol. 4, 1800271 (2019); P. Parandoush and D. Lin, Compos. Struct. 182, 36 (2017); F. Esteve et al., in Micro-Manufacturing Technologies and Their Applications, pages 67-95, (Springer, 2017); C. Greer et al., Addit. Manuf. 27, 159 (2019); P. Hackney et al., Int. J. Rapid Manuf. 10, 69 (2021); and C. Boutin et al., J. Appl. Phys. 117, 064902 (2015). While each AM process has its own design constraints, AM technology is rapidly improving and the many innovations in the field are pushing the manufacturing boundaries and reducing the design-limiting factors. However, AM has not been explored as a fabrication process to manufacture ILMs, even though AM is extensively used to manufacture lattices or metamaterials, which possess many of the same fabrication challenges as ILMs. See M. Askari et al., Addit. Manuf. 36, 101562 (2020).

According to the invention, AM can be an enabling manufacturing technology to achieve ILMs in a wider range of shapes, materials, and size scales. Moreover, ILMs can serve as a new joining strategy for AM-produced components. Joining additively manufactured parts is currently largely restricted to traditional joining techniques including welds, adhesives, and threaded fasteners. However, traditional joining technologies do not take advantage of the flexibility and agility of AM and constrain designs to allow for assembly (for example, the necessity to have line of sight and sufficient clearance to position and tighten a bolt). While adhesives and welds may be the prevalent technology to enable robust joining of intricate polymer and metal AM parts, respectively, they are intrinsically permanent joining solutions. In addition, they both necessitate careful surface preparation, and welds require special equipment and certified operators. Threaded fasteners offer non-permanent solutions, but are commonly subject to vibration loosening and often produce relatively weak joints. See R. W. Messler, Integral Mechanical Attachment: A Resurgence of the Oldest Method of Joining, (Elsevier, 2011). Furthermore, traditional joining techniques often fail to enable the assembly of complex AM-enabled geometries without cumbersome compromises. One example is lattices: there are today no performant solutions to assemble, in a robust manner, lattice structures.

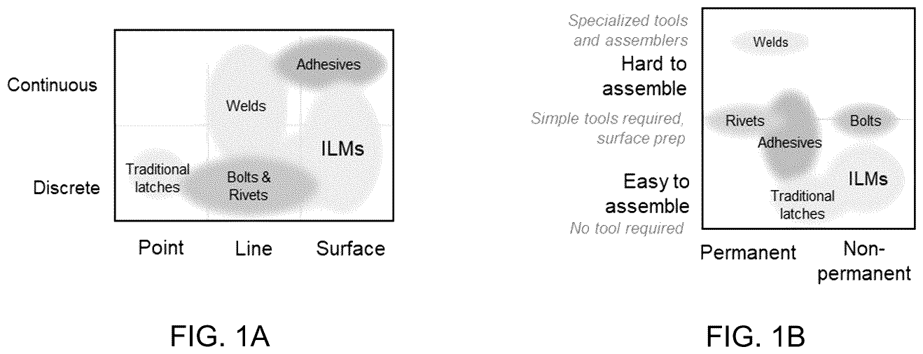

As a joining technology, the characteristics of AM-ILMs are distinct from, and complementary to, other common joining technologies such as welds, bolts, and adhesives. FIGS. 1A and 1B provide pragmatic comparisons of ILMs and traditional joining techniques. Depending on the feature arrangement, ILMs can act on a line or a surface, as shown in FIG. 1A. Consequently, they directly overlap with the application space of bolts and adhesives. As shown in FIG. 1B, two critical criteria that commonly drive joint technology selection during the design of assemblies are considered: ability to be disengaged (permanent vs non-permanent joint) and ease of assembly. Here, the ease of assembly is considered as a qualitative metric that includes the required joining energy, the process-induced residual stresses, the need for trained workers to perform the assembly (for e.g., welders), the required surface cleaning and preparation, the versatility of assembly (possibility of overhead assembly, joining of complex surfaces), the number and complexity of assembly tools, and the possibility of field assembly. ILMs are easy to assemble as they do not require line of sign for assembly nor specific tools, additional parts or specific surface preparation. As such, ILMs are a joining technology that is simultaneously non-permanent and easy to assemble. Thus, ILMs offer a new joining solution space that can be considered as an alternative to traditional joining techniques.

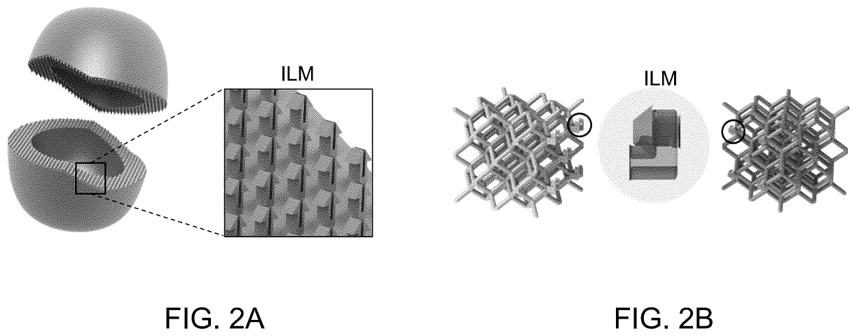

The application domain where ILMs can be used is vast. As an example, ILMs are used to join a vessel, as shown in FIG. 2A. Flat and inclined surfaces can be easily joined with a vertically engaged design such as the interlocking split arrowheads shown in the inset. As another example, ILMs can provide a joining solution for lattice structures, as shown in FIG. 2B. The figure shows a finger grip and pin ILM that can be used to join two lattices at selected nodes.

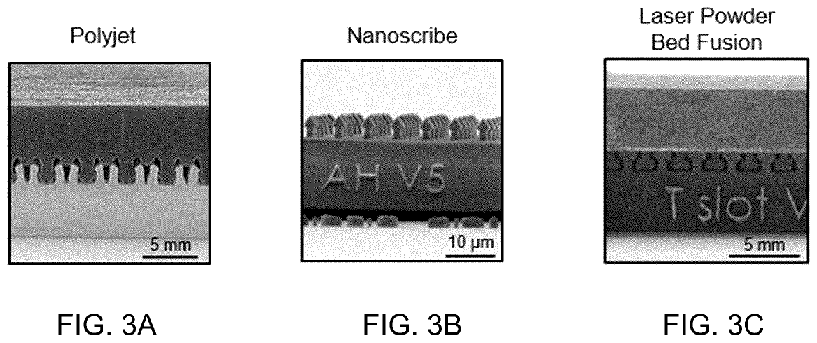

As will be described below, a variety of novel ILMs are enabled by additive manufacturing techniques. While the examples herein focus on a few specific ILMs manufactured by a few selected AM printing processes, ILMs can be manufactured in a variety of AM processes and in a broad range of materials, ranging from microscale polymers to ceramics to metals. Three AM manufacturing processes were used herein to demonstrate printability of ILMs: polyjet, multiphoton lithography, and laser powder bed fusion (LPBF). FIGS. 3A-3C show a subset of ILMs printed using various AM processes in both plastic and metal, which will be described in more detail later. FIG. 3A shows a split arrowhead ILM printed using the polyjet process in two materials (mixes of Vero™ and Agilus). FIG. 3B shows an arrowhead metasurface printed using the nanoscribe. FIG. 3C shows a T-slot ILM printed using the LBPF process.

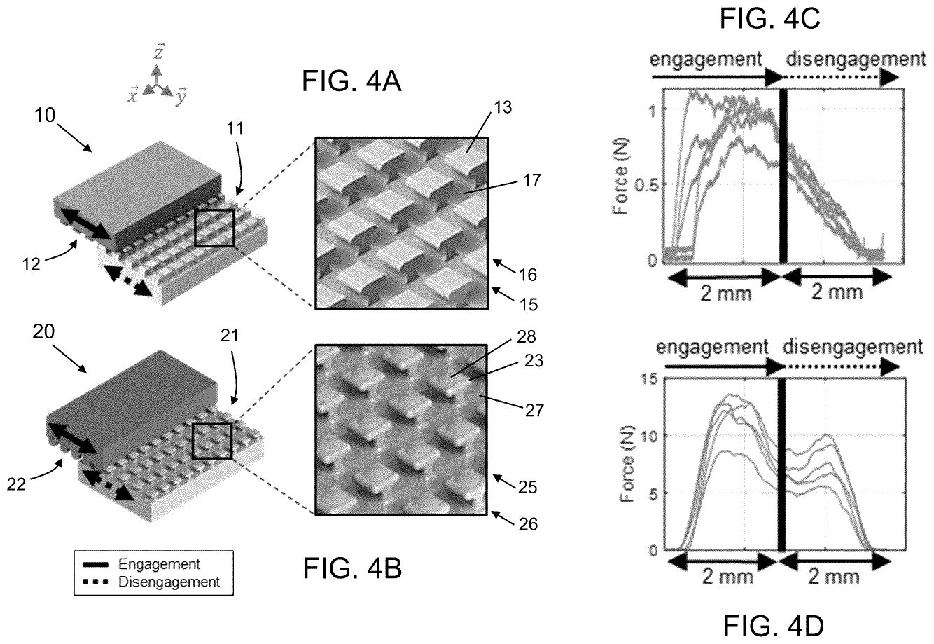

Table 1 details the processes used to manufacture the parts shown in FIGS. 4, 5, and 8. AM builds 3D objects using computer-aided designs (CADs). See S. L. Ford, J. Int. Commer. Econ. 6, 40 (2014). Therefore, all ILMs were first modeled using CAD software. A 0.2 mm tolerance was considered for polyjet and nanoscribe parts, and 0.5 mm tolerance for the metal parts. This tolerance was determined empirically to allow for the engagement of the mating metasurfaces. The polyjet samples were printed on an Objet J826 printer (Stratasys, Edina, MN) in Vero™ Cyan, Black, White and in mixtures of Vero™ and Agilus. The polyjet parts were printed in the original dimensions. The multiphoton lithography samples were manufactured on a Nanoscribe GT (Nanoscribe Inc., Karlsruhe, Germany) in IP-S photoresin. The metal parts were manufactured in 316 L stainless steel using a 3DSystems ProX200 (3D Systems, Rock Hill, CA). Dimensions remained identical for all polyjet prints and were uniformly scaled by a factor of 0.002 for the multiphoton lithography prints. For LPBF parts, the feature dimensions were modified to account for the maximum allowable overhang of free standing features. Mechanical testing samples were printed in Vero™ Cyan. All samples were printed with the feature profile aligned with the base plate which was also the layer surface. Support material was used and dissolved in a 3% potassium hydroxide solution for 2 hours. The parts were then rinsed with water and let to air dry for at least 24 hours before testing.

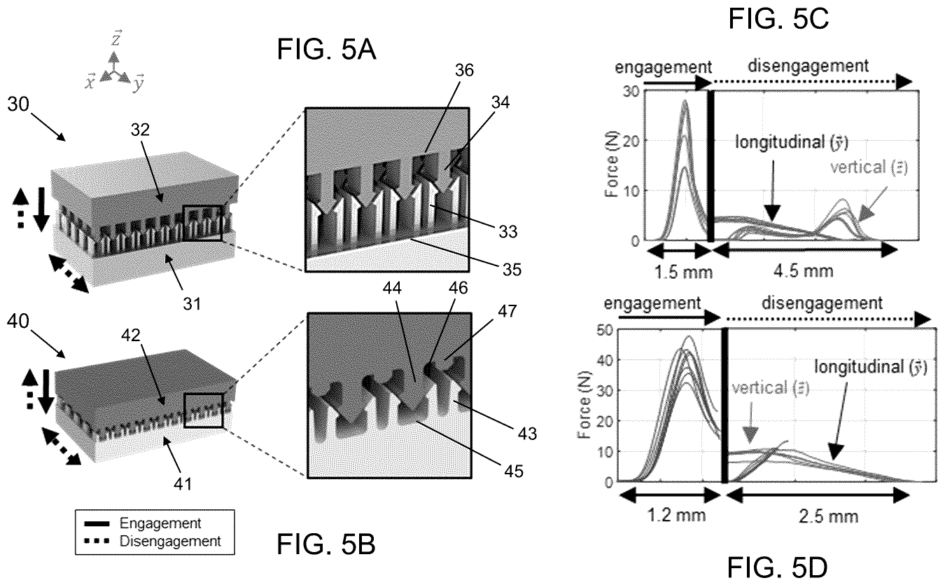

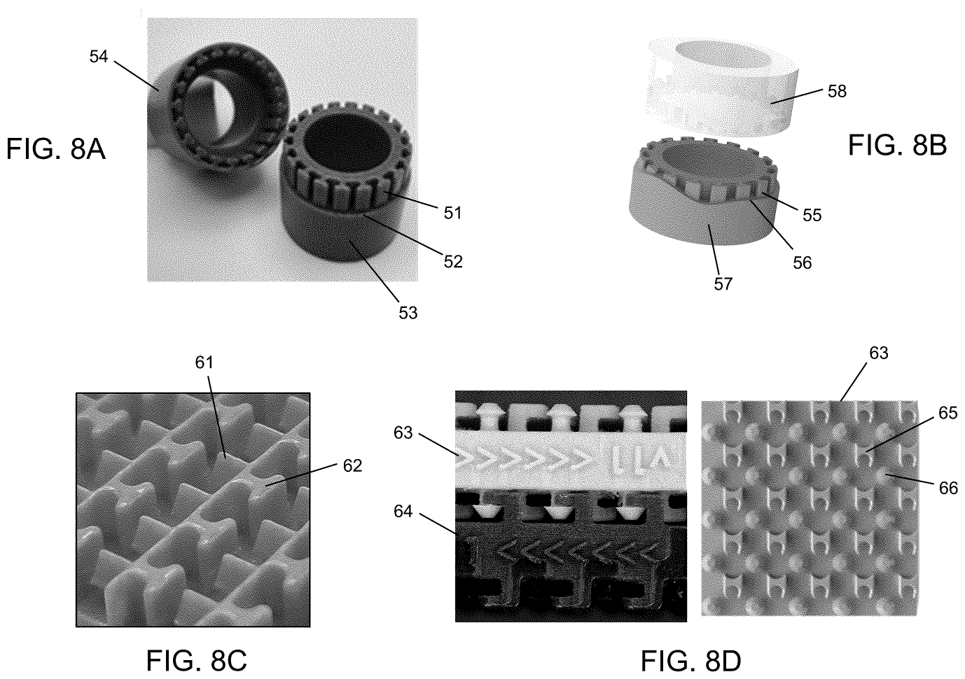

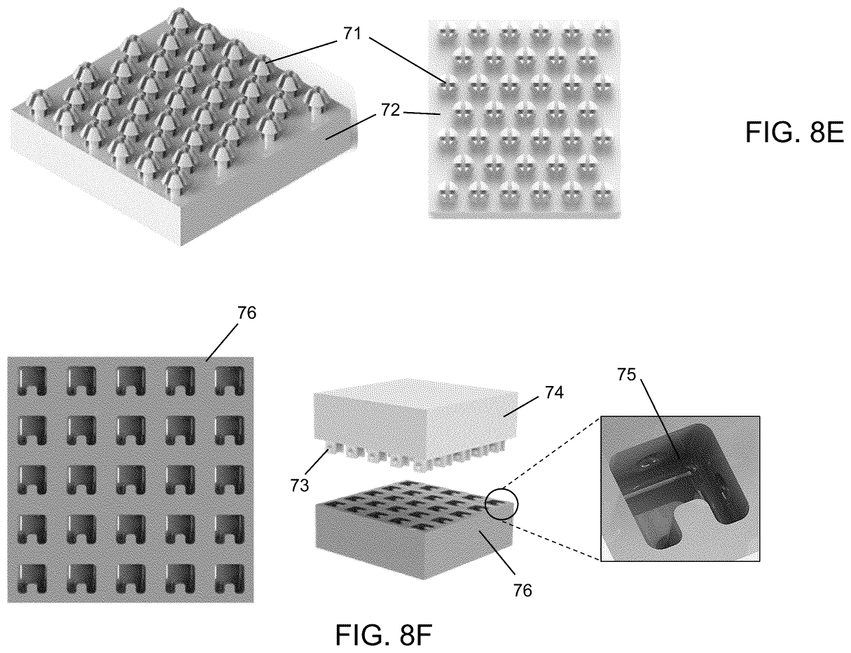

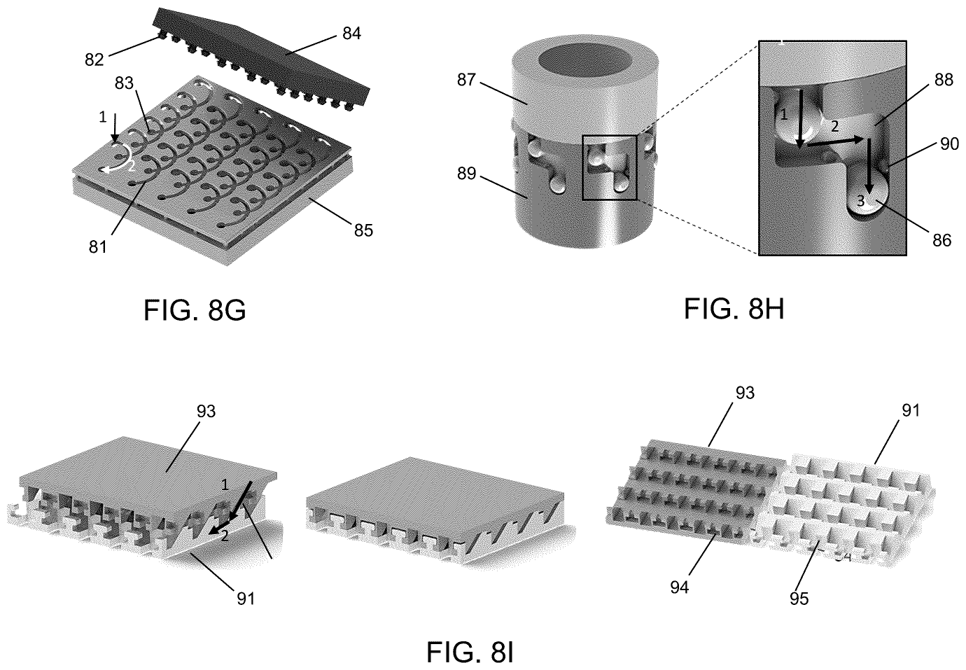

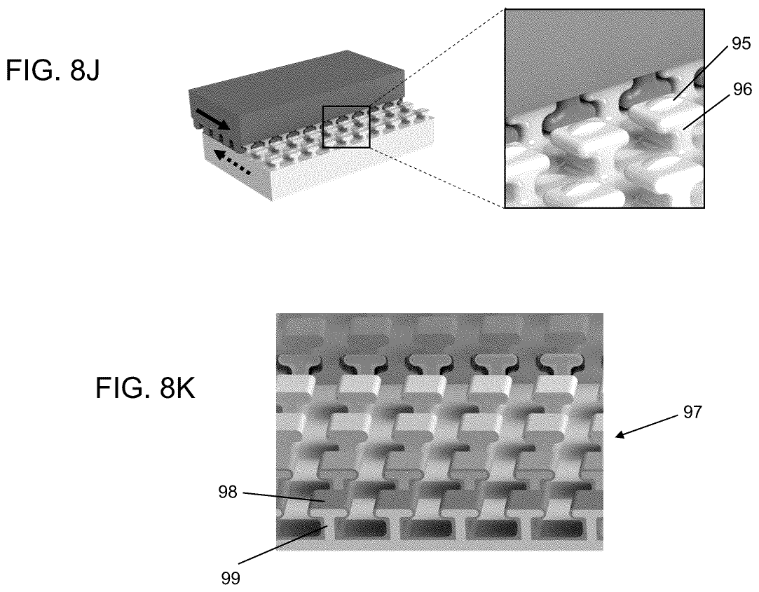

TABLE 1
ILM parts printed using various AM processes.

| | | Polyjet | | |
|---|---|---|---|---|
| | Polyjet | Material 2: | | |
| | Material 1: | Vero ™-Agilus | | |
| Reference | Vero ™ | mixture | LPBF | Nanoscribe |
| FIG. 3 | — | Locked split | Sliding | Split |
| | | arrowhead | T-slot | arrowhead |
| FIGS. 4, 5, | Vero ™ Cyan: | — | — | — |
| and 6 | Sliding and | | | |
| (mechanical | snapping T-slots; | | | |
| tests) | Split and locked | | | |
| | split arrowheads | | | |
| FIG. 8 | Sliding T-slot | All | — | — |

### Exemplary Interlocking Metasurfaces

For ILMs to form non-permanent, mechanically robust joints, the design space can be divided into three consecutive functional phases: the engagement, locked, and disengagement phases. During the engagement phase, both mating metasurfaces are placed in position to engage the interlocking features. During the locked phase, the mating metasurfaces are engaged and the features interlock to maintain the metasurfaces' engagement passively. In the disengagement phase, two scenarios are considered: intentional and unintentional disengagement. To create a mechanically robust joint, ILM designs that prevent disengagement in selected directions through mechanical interference are considered. In the unintentional disengagement directions, high forces need to be applied to disengage features through plastic deformation or element failure (delamination, feature “break off”, etc). Following these broad design considerations, simple and intuitive exemplary ILMs were developed. All exemplary ILMs are comprised of repeated identical units, although this is not a requirement for the ILMs.

Two exemplary ILMs 10 and 20 (FIGS. 4A and 4B) are based on interlocking T-shaped features 13 and 23 that comprise identical first and second mating metasurfaces 11 and 12, and 21 and 22 that connect in an A-A connector fashion. The exemplary ILM shown in FIG. 4A is referred to as a “sliding T-slot” and the exemplary ILM shown in FIG. 4B as a “snapping T-slot” 20. The arrayed T features 13 and 23 of both exemplary ILMs are 2 mm high, 2.6 mm wide, 2.5 mm long and are spaced 2.7 mm apart from each other (in the \vec{x} direction), thereby forming slots 15 and 25 in the \vec{y} direction. They form rows 16 and 26 of parallel T features that are spaced 4 mm apart in the \vec{y} direction. Both first T-slot metasurfaces 11 and 21 are engaged by a sliding action of the mating second metasurfaces 12 and 22, respectively, in the T-slots 15 and 25 along the longitudinal engagement direction (\vec{y}), parallel to the supporting surfaces 17 and 27. Depending on the initial position of the mating T features with respect one another, one or multiple parallel rows of T features can be connected. Once engaged, the ILMs are maintained in a locked position in the transverse (\vec{x}) and vertical (\vec{z}) directions by mechanical interference between adjacent T features. Both T-slot ILMs are symmetric and have colinear engagement and disengagement directions (\vec{y} in FIGS. 4A and 4B). The mating metasurfaces can be intentionally disengaged by sliding the mating metasurfaces past each other along the \vec{y} direction. However, the \vec{y} direction can be considered as a weak direction: for the sliding T-slot ILM 10, nothing but friction prevents unintentional disengagement in the \vec{y} direction. The snapping T-slot 20 is designed to improve robustness to unintentional disengagement by combining snapping features that create mechanical interference to prevent unintentional disengagement in the \vec{y} direction. A small dome 28 at the top of each T feature 23 creates an interference fit and latches in a snapping fashion into a conformal dimple on the opposing mating metasurface 22. The dome and dimple pairs create a stable locked configuration when the mating metasurfaces are engaged. The mating metasurfaces 21 and 22 can be engaged and disengaged by reversing their relative direction of motion or can slide in, lock, and then slide out in the same direction without reversing their relative motion.

Two more exemplary ILMs 30 and 40 (FIGS. 5A and 5B) involve arrow-like features 33, 34 and 43, 44 that protrude off of the supporting surfaces 35, 36 and 45, 46. The first and second mating metasurfaces 31 and 32, and 41 and 42 for these arrow-based ILMs 30 and 40 are not identical. The first metasurface 31 or 41 comprises “split” arrow features 33 or 43 while the mating second metasurface 32 or 42 is comprised of “full” arrow features 34 or 44. The exemplary arrow-based ILM shown in FIG. 5A and is referred to as the “split arrowhead” 30. The exemplary ILM shown in FIG. 5B is referred to as the “locked split arrowhead” 40. Both arrowhead ILMs 30 and 40 are engaged vertically in a snapping fashion by slightly pressing the full and split arrows past each other along the \vec{z} direction. The split arrowhead features 33 and 43 act as cantilevers to engage the ILMs. As the mating metasurfaces are pressed against one another during engagement, the split arrow features 33 and 43 elastically bend in the x direction to engage with the full arrow features 34 and 44. The split arrow tips (horizontal base of the triangular feature) create an interlock with the mating full arrow features as the split arrows recoil back to their original undeformed state following engagement. Both ILMs differ by the dimensions of the arrows. Further, the locked split arrowhead ILM 40 comprises wedges 47 that are stacked in between the arrow features 44. These wedges 47 act as inserts and allow for further bending the split arrows 43 once they are engaged to maximize the contact surface between the arrow tips and increase the region of mechanical interference. In both arrowhead ILMs 30 and 40, the metasurfaces 31, 32 and 41, 42 can be disengaged by sliding the arrowheads past each other horizontally, since there is no interference in the \vec{y} direction. In this case, the engagement and disengagement directions are not colinear. Both ILMs 30 and can also be disengaged vertically (in the \vec{z} direction) by pulling apart the interlocked metasurfaces. The features of the exemplary split arrowhead ILM 30 are 3.9 mm high, 1.4 mm wide, and 2 mm thick for the full arrows and 3.8 mm high, 0.8 mm wide, and 2 mm thick for the split arrows. The full arrows are spaced 3.3 mm and the split arrow 1.2 mm apart from each other in the direction and 2.2 mm in the \vec{y} direction. The features of the exemplary locked split arrowhead ILM 40 are 2.3 mm high, 1.5 mm wide, and 2 mm thick (full arrows) and 1.8 mm high, 2 mm wide, and 2 mm thick (split arrows). The wedges are 0.6 mm high, 0.9 mm wide, and 2 mm thick.

Three sets of tests were conducted to estimate the insertion and disengagement forces of the exemplary ILMs. Depending on the ILM design, the insertion force corresponded to engaging the mating parts in compression or longitudinal shear (direction \vec{y}; in FIGS. 4A, 4B, 5A, and 5B). The intentional disengagement forces corresponded to disengaging the assembly in longitudinal shear (direction \vec{y}) or tension, and the unintentional disengagement forces to disengagement in tension. Table 2 shows the engagement and disengagement directions for each design and the tests conducted as part of this study. For tension tests, metasurfaces comprised of 25 features (5 by 5 arrays) were first fully engaged and loaded. For the longitudinal shear tests (double lap shear), 3 by 3 arrays were aligned, but were not engaged until the test started. The transverse shear unintentional disengagement (direction forces were not tested as part of this study. The tests were performed on a Test Resources (TestResources Inc., Shakopee, MN) screw driven load frame at a strain rate of 2×10⁻²/s. Commercial 2D Digital Image Correlation (DIC) software, VIC-Gauge (Correlated Solutions, Irmo, SC) was used to measure virtual extensometer strain. The virtual gauge length was selected to be the closest distance between the sample edges in the case of tension and compression, and the center of the laps in the double lap shear experiments. DIC images were acquired with a GS3-U3-41C6M Point Grey Grasshopper camera (Point Grey Research Inc., Richmond, BC, Canada) with Edmund Optics (Edmund Optics®, Barrington, NJ) lenses scaled so that the gauge length was larger than 50% of the field of view. samples were printed for each test, but due to the brittle nature of Vero™ Cyan, some features broke upon setup and were not included. At least five repetitions were performed per test type.

The measured engagement and disengagement forces normalized per number of features are shown in FIGS. 4C and 4D for the sliding T-slot 10 and snapping T-slot 20, respectively. FIG. 4C shows that the engagement force of the sliding T-slot ILM 10 increases as the T features slide to engage until reaching a maximum ranging between 0.82 and 1.13 N per feature which corresponds to full engagement. The disengagement curve is characterized by a decreasing force until the T features have passed each other and the metasurfaces are no longer engaged. As shown in FIG. 4D, the snapping T-slot ILM 20 engagement and disengagement force profile has a saddle-like shape: the engagement force initially increases to a maximum before decreasing to a local minimum that corresponds to full engagement, i.e., to the position at which the domes rest in their conformal dimple mating pair. The disengagement force profile is similar, although the force required is slightly lower. The lower disengagement force is due to permanent plastic deformation upon first engagement due to the interference fit between the domes and the opposite dimpled mating metasurface. Overall, the engagement and disengagement forces of the snapping T-slot (8.65 to 12.8 N per feature) are an order of magnitude greater than the sliding T-slot.

The arrowhead ILMs 30 and 40 are engaged vertically and can be disengaged by sliding the metasurfaces past each other or pulling them apart, resulting in two possible intentional disengagement force profiles, as shown in FIGS. 5C and 5D. Both arrowhead ILMs 30 and 40 have similar snapping engagement force profiles: the force increases as the split arrows bend out of the way to pass the full arrow features. Once arrows are engaged, the force decreases. The inclusion of the wedges on the locked split arrowhead ILM 40 results in a higher insertion and longitudinal disengagement force, as shown in FIG. 5D.

TABLE 2
ILM engagement and disengagement directions
and corresponding mechanical tests.

| | | Intentional | Unintentional |
|---|---|---|---|
| ILM | Engagement | disengagement | disengagement |
| T-slot | Direction: longitudinal | Direction: | Direction: tension |
| | shear (\vec{y} direction) | longitudinal shear | or transverse |
| | Test: longitudinal | (\vec{y} direction) | shear (\vec{x} and \vec{z} |
| | shear (3 × 3 arrays - | Test: longitudinal | direction) |
| | double lap shear) | shear (3 × 3 arrays - | Test: tension |
| | | double lap shear) | (5 × 5 arrays) |
| Snap- | Direction: longitudinal | Direction: | Direction: tension |
| ping | shear (\vec{y} direction) | longitudinal shear | or transverse |
| T-slot | Test: longitudinal | (\vec{y} direction) | shear (\vec{x} and \vec{z} |
| | shear (3 × 3 arrays - | Test: longitudinal | directions) |
| | double lap shear) | shear (3 × 3 arrays - | Test: tension |
| | | double lap shear) | (5 × 5 arrays) |
| Split | Direction: | Direction: | Direction: |
| arrow- | Preferred: vertical | Vertical (tension, | transverse shear |
| head | (compression, \vec{z} | \vec{z} direction) | Test: none. |
| | direction) | Longitudinal | |
| | Other: | shear (\vec{y} | |
| | longitudinal shear | direction) | |
| | (\vec{y} direction) | Tests: | |
| | Test: vertical | longitudinal | |
| | (compression - 5 × 5 | shear (3 × 3 | |
| | arrays) | arrays - double | |
| | | lap shear) | |
| | | tension (5 × 5 | |
| | | arrays) | |
| Locked | Direction: | Direction: | Direction: |
| split | Preferred: vertical | Vertical (tension, | transverse shear |
| arrow- | (compression, \vec{z} | \vec{z} direction) | Test: none. |
| head | direction) | Longitudinal | |
| | Other: | shear (\vec{y} | |
| | longitudinal shear | direction) | |
| | (\vec{y} direction) | Tests: | |
| | Test: vertical | longitudinal | |
| | (compression - 5 × 5 | shear (3 × 3 | |
| | arrays) | arrays - double | |
| | | lap shear) | |
| | | tension (5 × 5 | |
| | | arrays) | |

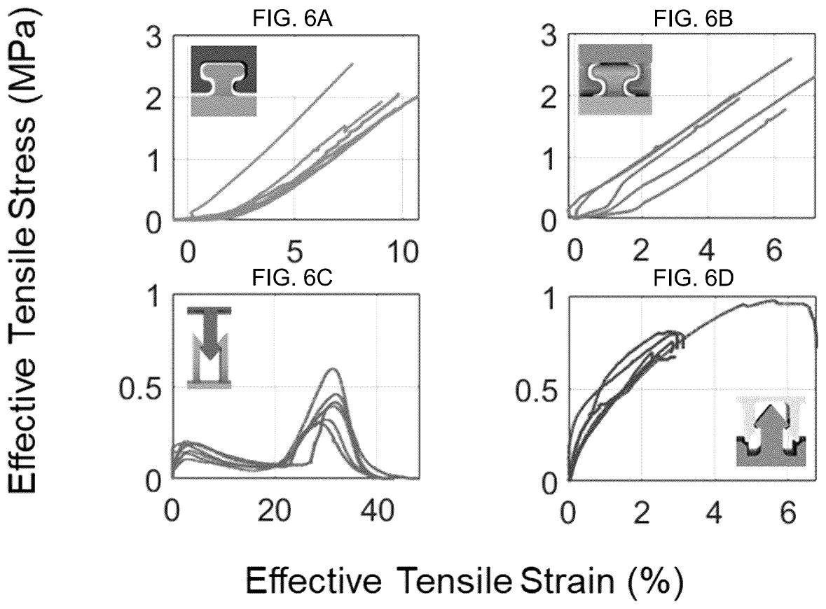

FIGS. 6A-6D show the experimental performance of the exemplary ILMs in tension. The tension tests for the two T-slot ILMs (FIGS. 6A and 6B) resulted in a similar maximum strength (1.97±0.28 and 2.12±0.32 MPa) for the sliding and snapping T-slots, respectively. However, the failure strain is markedly different (9.6±1.17 vs 6.06±1.02%). This difference can be attributed to different tolerances in the ILM designs: the sliding T-slot has a higher tolerance than the snapping T-slot which leads to an increase in strain before an increase in stress. The dome features of the snapping T-slot ILM create pre-strain in the tensile direction, leading to a sudden increase in the stress at low strains observed in FIG. 6B. The tension tests for the arrowhead ILMs are shown in FIGS. 6C and 6D and result in different maximum strength (0.40±0.11 vs 0.79±0.11 MPa) and strain at which that maximum occurs (30.6±1.36 vs 3.15±1.24%). The difference in tensile strength can be attributed to the additional wedges in the locked split arrowhead ILM. The wedges constrain the split arrowheads position to stay locked upon tensile disengagement. The difference in strain at which the maximum load occurs is due to the variation in the arrow dimensions between the two ILM designs: the split arrowheads are longer than the locked split arrowheads.

The above describes four simple interlocking metasurfaces. By leveraging three different AM processes, the designs were fabricated and the performance was experimentally investigated by estimating the insertion and disengagement forces and the tension strength. Below, the freedom allowed by AM expands the ILM designs beyond the initial exemplary designs and illustrates various ways the initial ILM design space can be broadened.

### Design Framework and Parametric Study

Creating interlocking action between features can be achieved by combining various design principles: contacting conformal metasurfaces, leveraging friction forces, through snap-fit interlocks, and mechanical interference. The exemplary ILMs in FIGS. 4A, 4B, 5A, and 5B follow these design principles. In these ILMs, mechanical interference, friction, and snap-fit characteristics enable the assembly of mating features and keep the metasurfaces engaged passively. The four exemplary ILMs have different responses (insertion and disengagement forces and directions, tension strength) that can leveraged to meet a set of design constraints. In all designs, feature topology can be modified to fine tune the metasurface assembly response.

This tuning can be aided by simulations of the ILM structures and their responses. The engagement and disengagement forces of selected ILM designs were estimated using finite element analysis (FEA). The use of FEA was facilitated as CAD models were already available from the AM builds. 2D planar models were considered. Half unit cells were simulated to vary topological parameters of the original CAD models. This first set of simulations was based on the assumption that the unit cells don't interact with one another and symmetry boundary conditions were applied on the side, top and bottom metasurfaces, accordingly. These simulations do not capture the response of the edge features, i.e., the response of the features at the edges of the metasurface that are only partially interlocked. Five unit cells simulations (2D planar) were developed to simulate the response of the actual prints and compare the FEA results to experimental data. These simulations aim to capture the response of a row of unit cells. Abaqus Explicit solver (Dassault Systems, Velizy-Villacoublay, France) was used to run all the simulations, although any other FEA software or code can be used. The material was considered linear elastic, with a Young's modulus in bending of 400 MPa, a coefficient of friction of 0.35 and a density of 1174 kg/m 3 to represent Vero™ Blue. The Young's modulus in bending was estimated by comparing FEA results (five unit cells 2D simulation) to experiment (5 by 5 compression and tension tests).

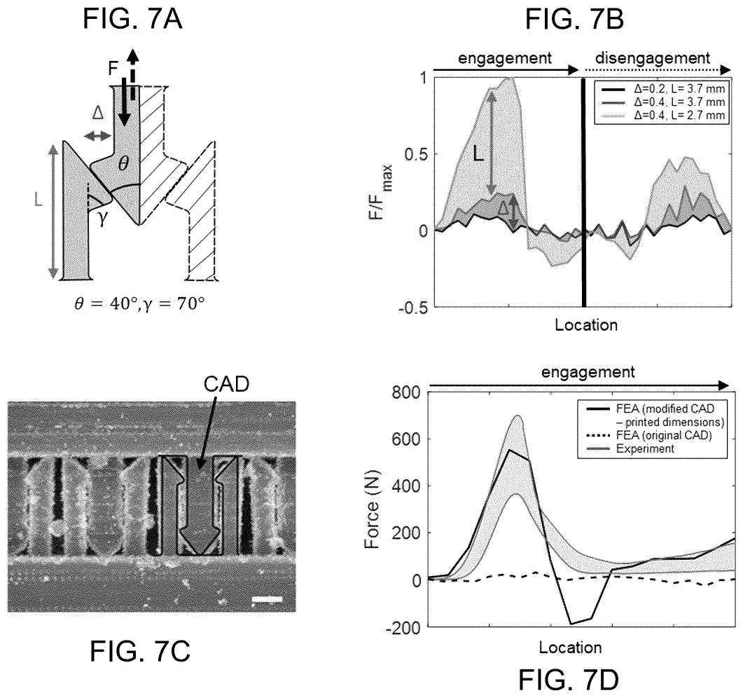

FIG. 7B shows envelopes of achievable responses of the split arrowhead ILM shown in FIG. 7A simulated using FEA. By reducing or increasing the length L of the cantilevers, the vertical insertion and disengagement forces increase and decrease respectively. The overlap A between the mating arrow features is another variable that greatly influences the force response. The overlap governs how much deflection the cantilevers are subjected to during engagement and can be varied by increasing the spacing between the features or modifying the arrowhead shape. It is apparent that the arrowhead angle θ and overhang angle γ can also be varied to control the engagement, locking, and disengagement forces. Furthermore, rather than use a single feature throughout the metasurface, the feature size and shape can be varied across the metasurface to provide progressive engagement and disengagement requirements. Therefore, by varying the feature topology, a broad solution space can be explored. In order to fine tune the response and performance of ILMs, optimization tools can be used to refine feature topology and placement on the metasurface.

### Material Selection and Manufacturing Processes

Additive manufacturing has enabled the exploration of the ILM design space by allowing the manufacturing of geometries that, until then, required relatively complex machining techniques. Using AM, designs can be quickly altered without changing the manufacturing process or parameters, or requiring the manufacturing of new tools such as micro molds previously used to fabricate ILMs using standard micromachining techniques. See A. G. Gillies and R. Fearing, J. Micromech. Microeng. 20, 105011 (2010). Nevertheless, AM presents unique constraints that must be considered in the design process. The primary process-agnostic considerations are the minimum feature size, the available build plate surface, and the ability to print freestanding features. The minimum feature size determines the spacing between features and, thus, the number of features that can be placed on a fixed surface. For ILMs, this directly effects the maximum number of load bearing features and thus the overall strength of the design. The minimum feature size and printing resolution also influences the surface roughness: innate surface roughness has been shown to increase as feature size decreases to approach the minimum feature size. See A. M. Roach et al., Addit. Manuf. 32, 101090 (2020). Surface roughness can lead to significant variations between the part's actual dimensions and the original CAD model. It introduces dimension variability in the manufactured parts which can greatly influence the actual forces and strength. In ILMs, surface roughness can be leveraged to increase the coefficient of friction and thus the maximum engagement and disengagement forces. The CAD models presented herein did not consider surface roughness as they focused on estimating the performance of designs fabricated in Vero™, which yields relatively smooth parts. However, surface roughness can be an important factor to consider in simulations when considering other materials (e.g., metal parts fabricated with LPBF). Indeed, surface roughness, interference, and dimensional tolerances can be intentionally designed to control these forces. Other forces that can be used to control the engagement, locking, and disengagement forces include capillary, magnetic, electrostatic, and Van der Waals forces. Liquid lubricants or solid lubricant coatings can also be used to reduce friction during engagement and disengagement, or mitigate effects such as galling.

Other AM constraints are process-specific. For example, printing orientation influences the effective material properties of polyjet parts, LPBF designs dimensions are restricted by the maximum overhang, and micro-scale ILMs (nanoscribe) present unique small size-specific challenges (i.e., assembly requires a micro manipulator and imaging instruments). Parts manufactured using the polyjet technology are printed sheathed in a gel-like support material. This support material enables the creation of freestanding structures with a large overhang span. However, all samples were subject to small drooping during printing and insuring that all the support material is uniformly removed without affecting the small features' structure is challenging. As a result, geometric variations were observed between the CAD models and the printed parts: drooping had the effect of smoothing the designs sharp edges, and likely left thin layers of support material affecting the initial engagement surfaces. FIG. 7C highlights the dimensional variations between the original split arrowhead CAD model and the true printed parts. While the overall length is almost identical, the printed parts are wider than the original CAD model. In this design, larger dimensions increase the stiffness of individual arrow heads, which leads to higher insertion and disengagement forces. FIG. 7D shows a simulation of the insertion force based on the original dimensions (dashed line). Due to the variation in dimensions, the insertion force is highly underestimated. By adjusting the dimensions of the model to reflect the true printed dimensions, the actual required insertion force (black line) can be simulated. Dimensional variability often generates undesirable effects such as unintended pre-loading of the features or looser assemblies which can decrease performance under fatigue and vibration. Thus, process-induced dimensional uncertainty should be taken into account to refine the design process. In a holistic optimization framework, both the AM process and the material would be considered at the design stage alongside the topology. See B. H. Jared et al., Scr. Mater. 135, 141 (2017). While holistic optimization tools are not currently readily available, they are of primary interest to accelerate the development of new ILM designs.

### Variations on the ILM Design and Features

A wide variety of ILM design and feature options are possible. The exemplary T-slot and split arrowhead features considered above are very simple. Because of the simplicity of these core features, they can be easily adapted to various surfaces to yield a palette of ILM solutions. For example, in addition to flat (planar) surfaces, the mechanically interlocking surface features can be fabricated on non-planar surfaces. For example, FIG. 8A shows sliding T-slot features 51 fabricating on a circular surface 52, allowing axial engagement and disengagement of cylinders 53 and 54 at a number of rotational angles. FIG. 8B shows sliding T-slots 55 an undulating circular surface 56, allowing full engagement of the cylinders 57 and 58 in only a specific rotational angle. The various orientations accommodate for vertical engagement and disengagement motions with the capability to sustain transverse loads.

Two or more different features can be combined on a single metasurface by matching engagement directions and compensating for intrinsic individual weaknesses. FIG. 8C shows an example of a hybrid design comprised of flat sliding T-slots 61 and split arrowheads 62 on a single metasurface. A mating ILM can engaged vertically and the arrowhead features help prevent unintentional vertical disengagement. The T features restrain in-plane motions and prevent transverse unintentional disengagement, creating a locked joint. The metasurfaces 63 and 64 in FIG. 8D utilize a finger-like locking geometry 65 to create the snap-fit with toadstool-like features 66 on the mating metasurface.

The surface features can be arrayed in a square grid pattern or a non-square pattern. For example, the features can be arrayed in a hexagonal pattern, as shown by the circular split arrowhead features 71 on the metasurface 72 in FIG. 8E, such that the mating metasurfaces can be locked into each other at every 60° of rotation. The spacing of the features can be varied (i.e., not uniform) on the metasurfaces such that a specific set of features on one metasurface can only engage with a set of features on the mating second metasurface, thereby allowing only one specific alignment of the mating metasurfaces. For example, the spacing of the features can be different in the two axes of the plane of the metasurfaces. The mechanically interlocking surface features need not be geometrically isotropic in the plane of the metasurface, as illustrated by the U-shaped surface features 73 arrayed in a square grid pattern on the first metasurface 74 and matching recesses 75 in the second metasurface 76 shown in FIG. 8F. In this example, the locking features are intentionally not geometrically isotropic in-plane, allowing engagement of the mating metasurfaces 74 and 76 only when there are aligned at a specific orientation relative to each other. Alternatively, the locking features can be geometrically isotropic in-plane, such that engagement is possible at different angles, depending on the directionality of the array features.

The engagement and disengagement directions need not be co-linear. For example, the slots 81 can provide a curved or arched path for engagement and disengagement of the mating features 82 and 83 on ILMs 84 and 85, as shown in FIG. 8G. The engagement and/or disengagement of the array features can use a multi-directional path or compound motion, such as a maze-like effect. The example in FIG. 8H involves a pin 86 that requires an axial and radial motion of cylinder 87 to slide into a zigzag slot 88 in the mating metasurface 89 and can be locked in place in a snapping fashion by small domed features 90 in the slot. The first metasurface 91 in FIG. 8I comprises an array of T-shaped surface features 92 that slide into the second metasurface 93 and then lock into hollow T-shaped mating features 94 to provide interlocking metasurfaces. ILMs can also be designed with interlocking features that can be used to discourage or prevent disengagement in one direction compared to another. FIG. 8J shows a modified snapping T-slot comprising a half-dome 95 at the top of each T feature 96 that requires stronger engagement and disengagement forces in one longitudinal direction as compared to the opposing longitudinal direction, providing a type of mechanical diode. Finally, the metasurface features can be designed to be permanently deformed upon engagement to prevent removal and re-use of the ILMs.

ILM designs can also leverage the multi-material capabilities of AM processes, in particular using polyjet printing technology. The polyjet process used herein allows for parts to be printed in a gradient of mixes between Vero™ and Agilus materials, offering the possibility to manufacture ILMs with a broad range of material properties. The mechanical properties can be localized across the metasurface by tailoring the material of each individual feature. For example, FIG. 8K shows a sliding T-slot metasurface 97 printed with a thin rubbery skin 98 around each T feature 99. The skin is composed of a different mix of Vero™ Black and Agilus. This ILM design can provide a gradient of properties to improve shock resistance on one part of the metasurface while maintaining high-load bearing capacities at other locations.

The present invention has been described as interlocking metasurfaces. It will be understood that the above description is merely illustrative of the applications of the principles of the present invention, the scope of which is to be determined by the claims viewed in light of the specification. Other variants and modifications of the invention will be apparent to those of skill in the art.

We claim:

1. Interlocking metasurfaces, comprising a first metasurface having a first array of mechanically interlocking surface features that mate with a second metasurface having a second array of mechanically interlocking surface features.

2. The interlocking metasurfaces of claim 1, wherein at least one of the first or second array of mechanically interlocking surface features comprises interlocking T-shaped features on a supporting surface.

3. The interlocking metasurfaces of claim 2, wherein the interlocking T-shaped features comprises a sliding T-slot.

4. The interlocking metasurface of claim 2, wherein the interlocking T-shaped features comprises a snapping T-slot.

5. The interlocking metasurfaces of claim 3, wherein the first array provides engagement by sliding the second array along a longitudinal direction parallel to the supporting surface.

6. The interlocking metasurfaces of claim 1, wherein at least one of the first or second array of the mechanically interlocking surface features comprises arrow-like features protruding off of a supporting surface.

7. The interlocking metasurfaces of claim 6, wherein the arrow-like features provide engagement by snapping the second metasurface in a vertical engagement direction perpendicular to the supporting surface.

8. The interlocking metasurfaces of claim 6, wherein the arrow-like features comprise a split arrowhead.

9. The interlocking metasurfaces of claim 6, wherein the arrow-like features comprise a locked split arrowhead.

10. The interlocking metasurfaces of claim 1, wherein the mechanically interlocking surface features of the first metasurface create an interlocking action with the mechanically interlocking surface features of the second metasurface and wherein the interlocking action comprises a friction force, snap-fit interlock, or mechanical interference.

11. The interlocking metasurfaces of claim 1, wherein the mechanically interlocking surface features of the first or second metasurfaces comprise a polymer, ceramic, or metal.

12. The interlocking metasurfaces of claim 1, wherein the mechanically interlocking surface features of the first and second metasurfaces comprise two or more different materials.

13. The interlocking metasurfaces of claim 1, wherein the mechanically interlocking surface features of the first and second metasurfaces are spaced less than 10 mm apart.

14. The interlocking metasurfaces of claim 1, wherein the first metasurface provides engagement with the second metasurface in a first direction and provides disengagement in a second direction that is colinear with the first direction.

15. The interlocking metasurfaces of claim 1, wherein the first metasurface provides engagement with the second metasurface in a first direction and provides disengagement in a second direction that is not colinear with the first direction.

16. The interlocking metasurfaces of claim 1, wherein the first metasurface provides engagement with the second metasurface along a complex multi-directional path.

17. The interlocking metasurfaces of claim 1, wherein the first metasurface provides engagement with the second metasurface along a curved path.

18. The interlocking metasurfaces of claim 1, wherein the first and second metasurfaces are planar.

19. The interlocking metasurfaces of claim 1, wherein the first and second metasurfaces are non-planar.

20. The interlocking metasurfaces of claim 1, wherein at least one of the first or second metasurfaces is permanently deformed upon engagement of the metasurfaces.

21. The interlocking metasurfaces of claim 1, wherein at least one of the first or second arrays of mechanically interlocking surface features is not geometrically isotropic in the plane of the first or second metasurface.

22. The interlocking metasurfaces of claim 1, wherein at least one of the first or second arrays of mechanically interlocking surface features is geometrically isotropic in the plane of the first or second metasurface.

23. The interlocking metasurfaces of claim 1, wherein at least one of the first or second arrays of mechanically interlocking surface features is arrayed in a square grid pattern.

24. The interlocking metasurfaces of claim 1, wherein at least one of the first or second arrays of mechanically interlocking surface features is arrayed in a non-square grid pattern.

25. The interlocking metasurfaces of claim 1, wherein a spacing of the mechanically interlocking surface features of at least one of the first or second arrays is not the same in the two axes in the plane of the first or second metasurface.

26. The interlocking metasurfaces of claim 1, wherein a spacing of the mechanically interlocking surface features of at least one of the first or second arrays is not uniform so as to provide engagement of the first and second metasurfaces with a specific relative orientation.

27. The interlocking metasurfaces of claim 1, further comprising a locking pin to prevent disengagement of the engaged first and second metasurfaces.

28. The interlocking metasurfaces of claim 1, further comprising a lubricant to control engagement and/or disengagement of the first and second metasurfaces.

29. The interlocking metasurfaces of claim 1, wherein the mechanically interlocking surface features of at least one of the first or second metasurfaces comprise two or more different types of surface features.

30. The interlocking metasurfaces of claim 1, wherein the mechanically interlocking surface features of at least one of the first or second metasurfaces are varied in size and/or shape across the metasurface.

31. The interlocking metasurfaces of claim 1, wherein at least one of the first or second metasurfaces is fabricated using an additive manufacturing process.

32. The interlocking metasurfaces of claim 31, wherein a surface roughness innate to the additive manufacturing process provides an interlocking action.

33. The interlocking metasurfaces of claim 1, wherein an interlocking action of the first and second metasurfaces is provided by a surface roughness and dimensional tolerances of the mechanically interlocking surface features.

34. The interlocking metasurfaces of claim 1, wherein an interlocking action of the first and second metasurfaces is provided by a capillary force, a magnetic force, an electrostatic force, or a Van der Waals force.

35. A method to fabricate an interlocking metasurface comprising an additive manufacturing process.

36. The method of claim 35, wherein the additive manufacturing process comprises a polyjet, multiphoton lithography, or laser powder bed fusion process.
